(19) United States
(12) Patent Application Publication
(10) Pub. No.: US 2007/0234601 A1
(43) Pub. Date: Oct. 11, 2007

(54) File divider with slidable tab

(76) Inventors: Steve Yoo, Brea, CA (US); Christie Yoo, Brea, CA (US); YeWon Min, Los Angeles, CA (US)

Correspondence Address: TROJAN LAW OFFICES, 9250 WILSHIRE BLVD, SUITE 325, BEVERLY HILLS, CA, 90212, US

(21) Appl. No.: 11/400,972

(22) Filed: Apr. 10, 2006

(51) Int. Cl. B42F 21/00; B65D 27/00

(52) U.S. Cl. 40/359

(57) ABSTRACT

File dividers having slidable tabs for systematic and efficient management of files are provided. A track is attached to a file divider such that the track runs substantially parallel to a file divider edge. A tab has a terminal end that wraps around a portion of the track to be capable of sliding along the track. In another embodiment, a slit running substantially parallel to a file divider edge is formed on an extended leaf, so that terminal portions of a tab can be inserted into the slit to be able to slide along the slit. In still another embodiment, a guiding track substantially parallel to a file divider edge slideably interlocks with a mating member of a tab. Lastly, a tab can have a pair of retention lips to hold a support bar or a track in order to be capable of sliding along the support bar or the track.

### FIELD OF THE INVENTION

The present invention relates to an information management apparatus and, more particularly, to file folders and dividers having sliding tabs for systematic and efficient management of files.

### BACKGROUND OF THE INVENTION

File dividers, such as manila file folders, hanging file folders, and tabbed dividers, with protruding tabs are widely used to organize files. The most common type of tab used in a manila file folder is one in which a portion of a folder surface is extended from one or both leaves of the file folder. The extended surface tab allows a user to write brief information identifying the file on the extended surface or to attach a label onto the surface.

The disadvantage of such tabs is that, when the user searches for a certain file in a crowded file drawer, the user has to thumb through folders until he finds the desired file because information written on the desired file folder tab is hidden by a similarly located tab of another file folder.

There have been attempts to solve the above problem inherent in conventional tab systems by allowing folder tabs to be placed in various locations along the folder edge. U.S. Pat. No. 4,905,393 issued to Charles T. Laurie teaches a re-locatable file tab having a forklike base that grips upon a folder edge by friction, wherein a flap extending from the base of the file tab has adhesive coating on a side of the flap so that the flap adheres to a surface of the folder. In the Laurie patent, in order to move the tab along the folder edge, the flap must be first peeled from the surface of the folder. Since the mobility and stability of the tab is based on the adhesive coating of the flap, after many times of relocating the tab by detaching and re-attaching the flap the adhesive coating would become lost and, accordingly, the file tab would not be able to function for its intended purpose.

Attempts to improve folder tabs for efficient file management have been made also with respect to hanging file folders. U.S. Pat. No. 6,332,285 B1 issued to Eric R. Aaldenbert, et al. and U.S. patent application Ser. No. 11/124,273 by Wallace N. Mark, et al. disclose positionable plastic tabs having two outwardly extending leg-like extensions frictionally engaging with the edge of a hanging folder. In order to move the plastic tabs in these references, the leg-like extensions are first released from engaging the edge of the hanging folder. The plastic tabs in these references are somewhat bulky and thick so that the plastic tabs would interfere with one another and take substantial space between hanging folders that are stored in a file drawer or storage. In addition, the complicated structure and material of such plastic tabs and their compatible hanging folders likely involve relatively high manufacturing costs.

### SUMMARY OF THE INVENTION

The purpose of the present invention is to provide file dividers with slidable tabs that maximize visibility of all tabs and overcome the disadvantages of conventional folder tabs.

In a first embodiment of the present invention, a thin-strip track is placed on a surface of a file divider near an edge such that the track runs parallel to the edge. A first end and a second end of the track are securely attached to the file divider by attachment means, such as glue, staple, sticky tape, or other similar means. A slidable tab has a terminal end that wraps around a portion of the track, so that the tab is capable of sliding along the track between the first end and the second end of the track.

Preferably, the file divider has an extended leaf that is extended from and folded at the edge to cover the track and the terminal end of the tab, thereby preventing the track and the tab from being damaged or stripped away by any contents used by the file divider. The extended leaf has a slot formed along a portion of the divider edge in order to allow the tab to be exposed through the slot for sliding along the track.

In another embodiment of a file divider with a slidable tab, an extended leaf of a file divider has a thin slit located proximately below the divider edge for receiving terminal portions of a slidable tab that comprises a first layer and a second layer. A first terminal portion of the first layer is flush with the inside surface below the slit of the extended leaf, and a second terminal portion, which is folded outward, is flush with the inside surface above the slit of the extended leaf.

As still another embodiment, a file divider has a guiding track (guiding track) attached in proximity to a file divider edge such that the guiding track runs substantially parallel to the divider edge. A tab has a mating member that is configured to interlock with the guiding track. The interlocking regions of the guiding track and the mating member are provided with a material having a sufficiently low friction to allow the mating member to be capable of sliding along the guiding track.

In another embodiment of a slidable tab, the slidable tab comprises a tab body and a pair of retention lips. The tab body comprises a first planar side and a second planar side. The retention lips are located on one of the planar sides of the tab body. The retention lips are configured to be capable of holding a support bar or a track, so that the tab can slide along the support bar or the track.

A file divider in the present invention may have a plurality of leaves as in a folder, or have only one leaf as in a divider of the kind used in a 3-ring binder. Slidable tabs in the present invention can be applied to a file divider having only one leaf as well as to a file divider having a plurality of leaves.

Since the slidable tabs in the present invention can slide along a track, a slit, a guiding track, a support bar, or a similar guiding means that is attached to a file divider, when a number of file folders are stored in a file drawer, a user can easily arrange the slidable tabs so that each tab is not hidden by another tab. Further, in the present invention the user does not have to remove the tab from the file divider in order to move the tab from one location to another at the edge of the file divider. In addition, due to the efficient configuration and structure of the sliding mechanism, the file divider with the slidable tab in the present invention maintains the thinness of a conventional file folder.

### BRIEF DESCRIPTION OF THE DRAWINGS

FIG. 1 is a plan view of one embodiment of a file divider as a folder with a slidable tab located in one position in full line configuration and in another position in dotted line configuration.

FIG. 1A is a side view of the slidable tab and a track of the embodiment shown in FIG. 1.

FIG. 2 is a plan view of another embodiment of a file divider with a slidable tab, wherein a track and the terminal end of the tab are covered by an extended leaf.

FIG. 3 illustrates construction of the extended leaf of FIG. 2.

FIG. 4 is a partial perspective view of another embodiment of a file divider with a slidable tab.

FIG. 5 is a partial perspective view of another embodiment of a file divider with a substantially T-shaped slidable tab.

FIG. 6 is a partial perspective view of another embodiment of a file divider with a slidable tab.

FIG. 7 is a cross-sectional view taken along lines 7-7 of FIG. 6.

FIG. 7A illustrates another embodiment of interlocking engagement of a guiding track and a mating member of a tab.

FIG. 8 is a partial perspective view of an embodiment of a hanging file folder with a slidable tab.

FIG. 9 is a perspective view of another embodiment of a slidable tab.

### DETAILED DESCRIPTION OF THE INVENTION

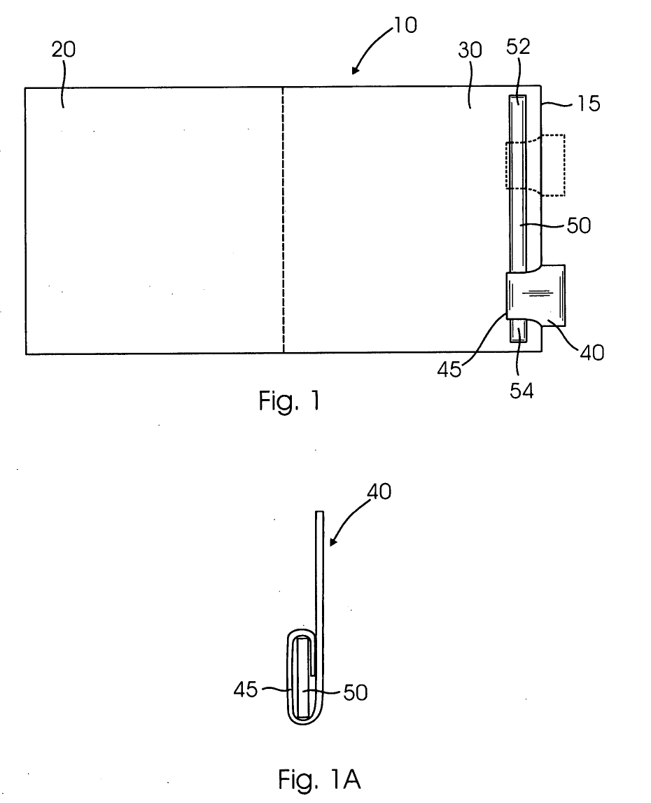

FIG. 1 illustrates a first embodiment of a file divider with a slidable tab. The file divider 10 in FIG. 1 comprises a plurality of leaves—a front leaf 20 and a back leaf 30. A thin-strip track 50 is located on inside surface of the back leaf 30 of the file divider 10 near a divider edge 15 such that the track 50 runs substantially parallel to the file divider edge 15. A first end 52 and a second end 54 of the track 50 are securely attached to the file divider 10 by glue, staple, sticky tape or any other attachment means. As shown in FIG. 1A, a slidable tab 40 has a terminal end 45 that wraps around the track 50 and then is secured to the tab itself by attachment means. This configuration allows the tab 40 to be capable of sliding along the track 50 between the first end 52 and the second end 54. The tab 40 has a top portion extending beyond the edge 15 such that, when the file divider 10 is folded to place the front leaf 20 in front of the back leaf 30, a user can still see the information recorded on the top portion of the tab 40. Since the tab 40 is capable of sliding along the track 50, when a number of file dividers having such slidable tabs are stored in a file drawer or box or binder, a user can easily arrange the tabs by moving them along the track so that each tab is not hidden by another tab. The user does not have to remove the tab from the file divider in order to rearrange the location of the folder tab.

The slidable tab and track can be made of any material that is thin enough to maintain the thinness of a conventional file folder, such as thin plastic, cardboard, or any material known in the art. Also, the slidable tab and the track can be made of the same material as used for the file divider. The user can apply identifying information of the file directly on the tab (e.g., tab made of cardboard) or can attach a label onto the tab (e.g., tab made of thin plastic). Alternatively, the tab may comprise two layers of transparent thin plastic, wherein an insert, a piece of paper, can be inserted therebetween.

Although FIG. 1 shows that the track 50 is placed on an inside surface of the back leaf 30 of the file divider 10, in another contemplated embodiment the track 50 can be placed on an inside surface of the front leaf 20. In still another embodiment, the track 50 can be placed on an outside surface of either the front leaf 20 or the back leaf 30.

With respect to the definition of a file divider in the present invention, a file divider may have a plurality of leaves as in a folder as shown in FIG. 1 or have only one leaf. One of examples of a file divider having only one leaf is a divider of the kind used in 3-ring binders, which is commonly known in the art. Slidable tabs in the present invention can be applied to a file divider having only one leaf in the same way as described for a file divider having a plurality of leaves.

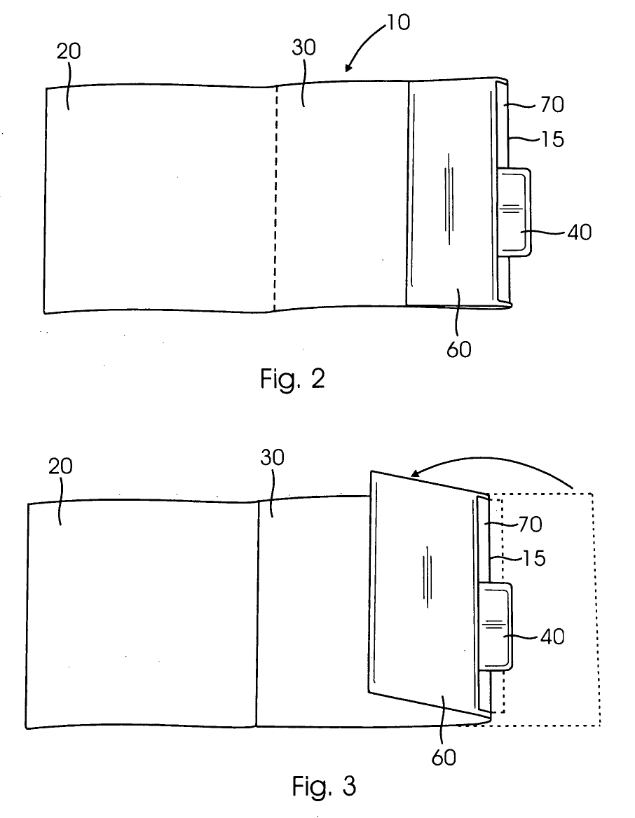

FIGS. 2 and 3 show a preferred variation of FIG. 1. The back leaf 30 where track 50 and the tab 40 are located has an extended leaf 60, which is extended from and folded at the file divider edge 15 to cover the track 50 and the terminal end 45 of the tab 40. The extended leaf 60 has a thin slot 70 along a portion of the file divider edge. The tab 40 is exposed through the slot 70 so that the tab 40 can freely slide along the track 50 without obstruction. The inside surface of the extended leaf 60 is glued or similarly attached by attachment means to the back leaf 30, but a portion covering the track 50, the terminal end 45 of the tab 40, and the path for the slide movement of the tab 40 remains separate from the back leaf 30 in order not to interfere the movement of the divider tab 40.

The presence of the extended leaf 60 covering the track 50 and the terminal end of the slidable tab 40 prevents the track 50 or the divider tab 40 from being damaged or stripped away by documents or other contents kept in the file divider 10.

The track 50 can be attached to one of the file divider leaves as described above, or to the inside surface of the extended leaf 60 in proximity to the slot 70.

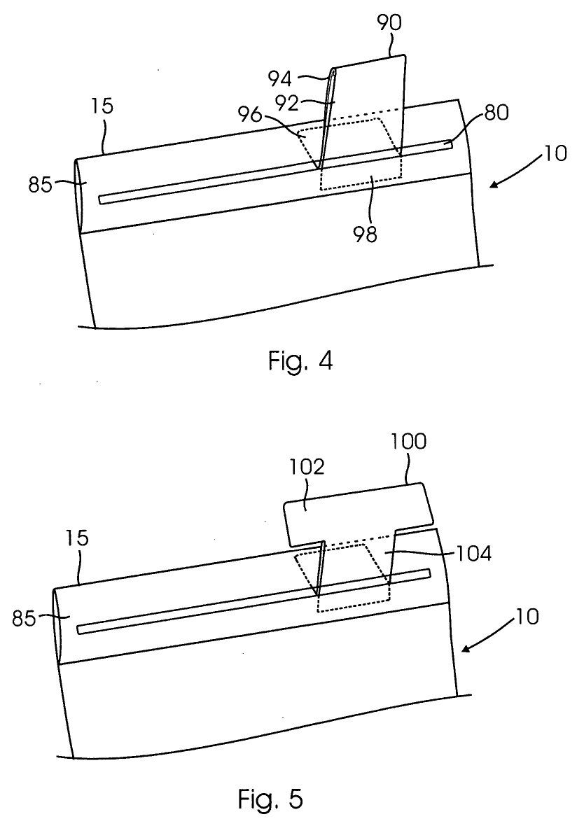

FIG. 4 illustrates another embodiment of a file divider having a slidable tab. The extended leaf 85 has a thin long slit 80 proximately below the divider edge 15. A tab 90 folded to comprise a first layer 92 and a second layer 94. While a first terminal portion 98 of the first layer 92 remains on substantially the same plane as the surface of the first layer 92, a second terminal portion 96 of the second layer 94 is folded outward. The first terminal portion 98 and the second terminal portion 96 of the tab 90 are inserted into the slit 80 such that the first terminal portion 98 of the first layer 92 is flush with a portion of an inside surface below the slit 80 of the extended leaf 85, and the second terminal portion 96 is flush with a portion of an inside surface above the slit 80 of the extended leaf 85. This configuration allows the tab 90 to slide along the slit 80 without being departed from the file divider 10.

Various shapes of tabs can be used as the user desires. For example, a tab can be in a rectangular or a square shape as shown in FIG. 4. As another example, a tab can be substantially T-shaped as shown in FIG. 5. Since the substantially T-shaped tab 100 has a wider top portion 102 for recording information than a body 104, it provides more space for recording information without reducing the range of sliding movement of the tab. In addition, the substantially T-shaped tab allows the edge of the tab to slide all the way to the edge of the file divider itself, thereby increasing the range within which the tab may be moved and arranged.

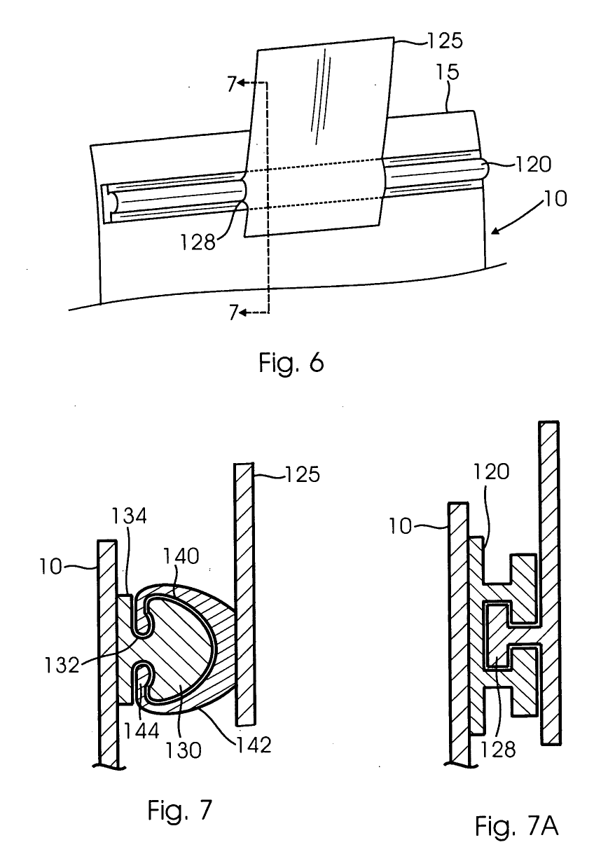

FIG. 6 shows still another embodiment of a slidable tab. The file divider in FIG. 6 has a guiding track 120 attached to the file divider such that the guiding track 120 runs substantially parallel to the divider edge 15. A tab 125 has a mating member 128 that is configured to interlock with the guiding track 120. The interlocking regions of the guiding track 120 and the mating member 128 are provided with a material having a sufficiently low friction to allow the mating member 128 to be capable of sliding along the guiding track 120. The guiding track 120 and the mating member 128 of the tab 125 can be in any shape so long as the mating member 128 can slideably interlock with the guiding track 120. For example, as shown in FIG. 7, the guiding track 120 has a male element 130, and the mating member 128 has a female element 140. The male element 130 in FIG. 7 protrudes from a base 134 of the guiding track 120 and its cross-section is in a shape similar to a mushroom. However, the male element can be in any shape such as an arrow, rectangular, or oval shape. The mating member 128 comprises a plurality of elongated legs 142 to form the female element 140. The legs 142 are configured to interlock with the male element 130. In particular, a tip 144 of each leg 142 is directed inward to engage a recess area 132 of the male element 130.

In another embodiment, the guiding track has a female element, and the mating member of the slidable tab has a male element configured to interlock with the female element. In still another embodiment, as shown in FIG. 7A, the guiding track can have a plurality of male elements and a female element that is formed between the male elements. The mating member of the slidable tab has also a male element that is configured to fit into the female element of the guiding track. Alternatively, the mating member of the tab can have a plurality of male elements and a female element that is formed between the male elements, and the guiding track can have a male element that is configured to interlock with the female element of the mating member. In still another embodiment, a file divider can have a plurality of guiding tracks, which align side by side. A slidable tab for this embodiment has a plurality of mating members in corresponding locations in order to interlock with each of the guiding tracks.

The configuration and the size of the mating member and the guiding track can be similar to or the same as those of the closures commonly used in reclosable plastic bags. Also, the material used for such closures of reclosable plastic bags or other similar material can be used for the mating member and the guiding track.

The entire slidable tab 125 can be made of the same material, or the material used for the mating member 128 can be different from that for the rest of the slidable tab 125. For example, plastic mating member 128 can be attached to a piece of cardboard to form a slidable tab 125.

Due to the interlocking engagement of the mating member 128 and the guiding track 120, the slidable tab 125 is not detached from the guiding track 120 while sliding along the guiding track 120. However, the mating member 128 is resiliently flexible enough to be released from the interlocking engagement if the user pulls out the slidable tab 125 in a direction perpendicular to the plane of the file divider surface. This allows the user to change an old tab to a new one.

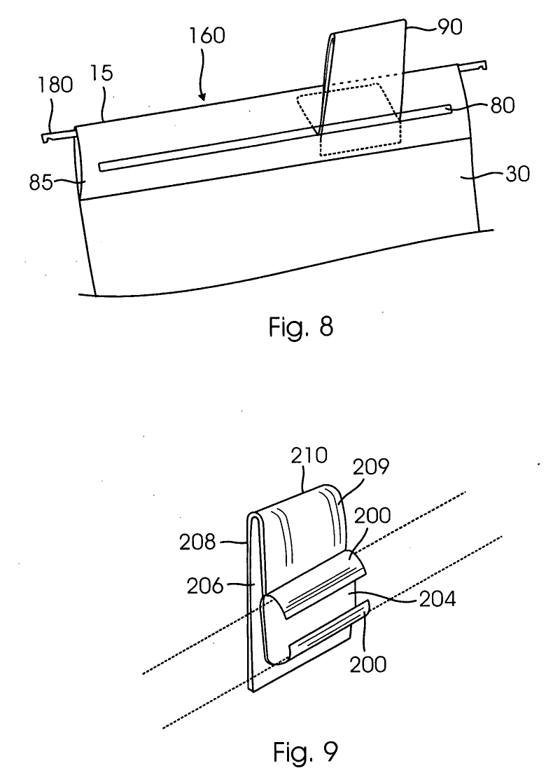

All of the embodiments described above and illustrated in FIGS. 1 through 7A can be applied to hanging file folders as well as to other conventional file folders. For example, the embodiment of FIG. 4 is applied to a hanging file folder 160 in FIG. 8. A support bar 180 of the hanging folder 160 is placed between a main leaf 30 and an extended leaf 85 at the folder edge 15. The slit 80 of the extended leaf 85 is located proximately below the support bar 180. The terminal portions 96, 98 of the folder tab 90 are inserted into the slit 80 and flush with the inside surface of the extended leaf 85 as described above regarding FIG. 4.

In another embodiment as shown in FIG. 9, a slidable tab 210 may comprise a tab body 206 and a pair of retention lips 200. The tab body 206 comprises a first planar side 208 and a second planar side 209. The retention lips 200 are located on one of the planar sides of the tab body 206. The retention lips 200 are configured to be capable of holding a support bar 180 or a track 50, so that the tab 210 can slide along the support bar 180 or the track 50. The tab body 206 and the retention lips 200 can be formed in one piece. Alternatively, a pair of retention lips 200 can be extended from a support surface 204, which is a separate piece from a tab body 206. The support surface 204 is secured to the tab body 206 to form a tab 210.

In order for tab 210 to be used in a hanging file folder, the folder has a cut (not shown) located along a portion of the folder edge 15 such that a portion of the support bar 180 is exposed to engage the folder tab 210. The retention lips 200 of the folder tab 210 can be inserted into the cut to releasably hold the support bar 180 so that a portion of the folder tab 210 is exposed through the cut for sliding along the support bar 180. Preferably, the retention lips 200 are resiliently flexible enough to be releasable from engaging the support bar 180, for the user to be able to replace an old tab with a new one.

Alternatively, a hanging folder or any other file folder can have a track 50 placed proximately below a support bar 180 or a folder edge 15, and the retention lips 200 can hold the track 50 such that the folder tab 210 is capable of sliding along the track 50.

The present invention has been described in an illustrative manner, and it is to be understood that the terminology used is intended to be in the nature of description rather than of limitation. Many modifications and variations of the present invention are possible in light of the above teachings. Therefore, it is to be understood that within the scope of the appended claims, the invention may be practiced otherwise than as specifically described.

1. A file management apparatus comprising:
a file divider having at least one leaf;
a track having a first end and a second end, the first end and the second end being attached to the file divider such that the track runs substantially parallel to a file divider edge of the file divider; and
a tab having a terminal end, the terminal end wrapping around a portion of the track, so that the tab is capable of sliding along the track.

2. The file management apparatus of claim 1, wherein the file divider comprises a plurality of leaves.

3. The file management apparatus of claim 1, wherein the file divider further comprises an extended leaf and a slot, the extended leaf being extended from and folded at the file divider edge to cover the track and the terminal end of the tab, the slot being formed along a portion of the file divider edge such that a portion of the tab is exposed through the slot to slide along the track.

4. The file management apparatus of claim 3, wherein the first end and the second end of the track are attached to an inside surface of the extended leaf, the track being located in proximity to the slot.

5. The file management apparatus of claim 1, wherein the tab further comprises a top portion and a body, the top portion being exposed beyond the file divider edge, the top portion being broader than the body such that the tab is substantially T-shaped.

6. A file management apparatus comprising:
a file divider having at least one main leaf and an extended leaf, the extended leaf being extended from and folded at an edge of a main leaf, the extended leaf having a slit running substantially parallel to the edge of the main leaf; and
a tab being folded to comprise a first layer and a second layer, the first layer having a first terminal portion, the second layer having a second terminal portion, the second terminal portion being folded outward,
the first terminal portion and the second terminal portion being inserted into the slit such that the first terminal portion is flush with a portion of an inside surface of the extended leaf proximately below the slit, and the second terminal portion is flush with a portion of an inside surface of the extended leaf proximately above the slit,
the tab being capable of sliding along the slit.

7. The file management apparatus of claim 6, wherein the tab is transparent.

8. The file management apparatus of claim 7, wherein the tab further comprises an insert for recording information, the insert being inserted between the first layer and the second layer.

9. The file management apparatus of claim 6, wherein the tab further comprises a top portion and a body, the top portion being exposed beyond the edge of the leaf, the top portion being broader than the body such that the tab is substantially T-shaped.

10. The file management apparatus of claim 6, wherein the file divider further comprises a support bar, the support bar being secured between the main leaf and the extended leaf at the edge of the main leaf.

11. A file management apparatus comprising:
a file divider having at least one leaf;
a guiding track attached to the file divider such that the guiding track runs substantially parallel to a file divider edge of the file divider; and
a tab having a mating member, the mating member configured to interlock with the guiding track such that the tab is capable of sliding along the guiding track.

12. The file management apparatus of claim 11, wherein the guiding track and the mating member, at least in an interlocking region thereof, are provided with a material having a sufficiently low friction to allow the mating member to be capable of sliding along the guiding track.

13. The file management apparatus of claim 11, the guiding track having a male element, the mating member having a female element, the male element and the female element being configured for interlocking engagement.

14. The file management apparatus of claim 11, the guiding track having a female element, the mating member having a male element, the female element and the male element being configured for interlocking engagement.

15. The file management apparatus of claim 11, the file divider further comprising an extended leaf and a slot, the extended leaf being extended from and folded at the file divider edge to cover the guiding track and the mating member of the tab, the slot being formed along a portion of the file divider edge such that a portion of the tab is exposed through the slot to slide along the guiding track.

16. The file management apparatus of claim 15, wherein the guiding track is attached to an inside surface of the extended leaf and is located in proximity to the slot.

17. A file management apparatus comprising:
a tab comprising a tab body having a first planar side and a second planar side,
a pair of retention lips being on one of the planar sides,
the retention lips together being capable of securing the tab to a file divider.

18. The file management apparatus of claim 17, further comprising:
a file divider comprising a main leaf, an extended leaf, and a support bar,
the extended leaf being extended from and folded at an edge of the main leaf,
the support bar being secured between the main leaf and the extended leaf at the edge of the main leaf,
the file divider having a cut located along a portion of the edge,
the retention lips being inserted into the cut to hold the support bar such that the tab is capable of sliding along the support bar.

19. The file management apparatus of claim 17, further comprising:
a file divider having at least one leaf; and
a track having a first end and a second end, the first end and the second end being attached to the file divider such that the track runs substantially parallel to an edge of the file divider,
the retention lips holding the track such that the tab is capable of sliding along the track.

20. The file management apparatus of claim 19, the file divider further comprising an extended leaf and a slot, the extended leaf being extended from and folded at the file divider edge to cover the track and the retention lips, the slot being formed along a portion of the file divider edge such that a portion of the tab is exposed through the slot to slide along the track.
